(19) United States
(12) Patent Application Publication
(10) Pub. No.: US 2015/0082640 A1
(43) Pub. Date: Mar. 26, 2015

(54) Locking Mechanism for a Folding Knife

(71) Applicant: Glen Forrest Huff, Riverton, UT (US)

(72) Inventor: Glen Forrest Huff, Riverton, UT (US)

(21) Appl. No.: 14/034,146

(22) Filed: Sep. 23, 2013

(51) Int. Cl. B26B 1/04

(52) U.S. Cl. CPC B26B 1/04
USPC 30/161

(57) ABSTRACT

A liner lock folding knife with an improved liner lock mechanism which provides increased safety in use. The locking mechanism provides for simple one-handed operation and the ability to tactilely know when the blade is securely locked in the open position.

### BACKGROUND OF THE INVENTION

The present invention relates to folding knives, and in particular to an improved blade-locking mechanism for a folding knife with added safety features.

The prior art employed a liner lock to keep the blade of the folding knife locked in place while in use and will be well known to one familiar with the art. A liner is a thin metal sheet that is placed along the inside of the scale of a folding knife, next to the blade. A section of this liner is cut and bent to produce a spring action so that when the blade is opened, it snaps inward, wedging itself against the blade and thus locking the blade in the open position. The lock is also cut in such a way that the lower edge extends slightly below the edge of the scale. To disengage the lock, pressure is exerted against this edge to push the locking element of the scale back against the body of the scale, freeing the blade so that it may be closed.

Such a design has been disclosed in Walker U.S. Pat. No. 4,896,424 and Weatherly U.S. Pat. No. 5,755,035 where a locking finger is cut into the liner of a folding knife and engages with the back of the blade locking it in the open position.

This design can create complications for the user. In order to open the blade, the user must either pull out the blade with the fingers from the opposite hand, or use a thumb stud, thumb hole built into the blade or flipper built into the blade, if opening the knife one-handedly. Even with these modifications, one-handed opening can be difficult, particularly if the user is wearing gloves or if the knife or hands are wet. Typically, the user relies on a “click” as the blade settles into the lock to inform them that the lock has engaged. If the lock fails to fully engage as a result of the aforementioned complications or due to its design, the blade could close unexpectedly on the user's fingers and cause injury. To unlock and close the knife, the user has to press the locking element against the side of the knife handle, and in the process, the user's fingers are put in the path of the blade, which also risks injury.

### BRIEF SUMMARY OF THE INVENTION

The present invention uses a unique lock design and floating pivot which work in tandem to create the locking and unlocking actions and should be understood by one familiar with the art. The liner inside the knife handle acts as the lock, similar to knives of the prior art, but in the present invention the lock is cut from within the center of the liner, rather than along the edge of the liner. The lock terminates at the floating pivot, which is the mechanism that allows the blade to pivot and acts as a release for the lock and allows the user to tactilely detect that the blade is fully engaged. This lock is bent in such a way as to provide a spring action which facilitates the engagement of the lock. To facilitate opening the blade, a tang is provided which extends outward from the back of the blade. Rotational pressure on the tang allows for opening the blade with one hand, even in non-optimal conditions. As the blade is opened, the lock is automatically engaged by the force of the spring, pushing the lock into the notch which has been cut into the blade. The terminal end of the lock resides in a groove which is cut into the body of the floating pivot and when the lock is engaged, it pushes the floating pivot from one side of the knife to the other. To disengage the lock, the floating pivot is pressed to the opposite side of the knife, returning it to its original position, which forces the lock out of the notch in the blade and against the scale, freeing the blade and allowing it to fold shut. The position of the floating pivot prevents the user's fingers from being in the path of the blade at any time.

The present invention's locking mechanism and ease of use resolve the concerns related to the prior art, which were noted in THE BACKGROUND OF THE INVENTION. Whereas folding knives of the prior art have no simple way to discern whether a lock is fully engaged, the present invention's floating pivot serves as both a visual and tactile method to detect whether the knife has been properly locked. Furthermore, the user can keep the thumb on the pivot during use as a safety precaution. By disengaging the lock at the pivot, the user does not have to place their fingers in the travel of the closing blade and the risk of injury is reduced. Additionally, the present invention's design improves the ease of use tremendously over knives in the prior art. The user can easily disengage the lock with one hand, even in poor weather or while wearing gloves.

### BRIEF DESCRIPTION OF THE SEVERAL VIEWS OF THE DRAWING

FIG. 1 is an exploded view of the knife.

FIG. 2 shows a detailed view of the floating pivot in end view and cross-section view, as well as a view of the floating pivot attached to the liner.

FIG. 3 is a cross section view through the center of the floating pivot showing the lock engaged and disengaged.

FIG. 4 shows the fully assembled knife, with the blade opened and the stone insets in place.

### DETAILED DESCRIPTION OF THE INVENTION

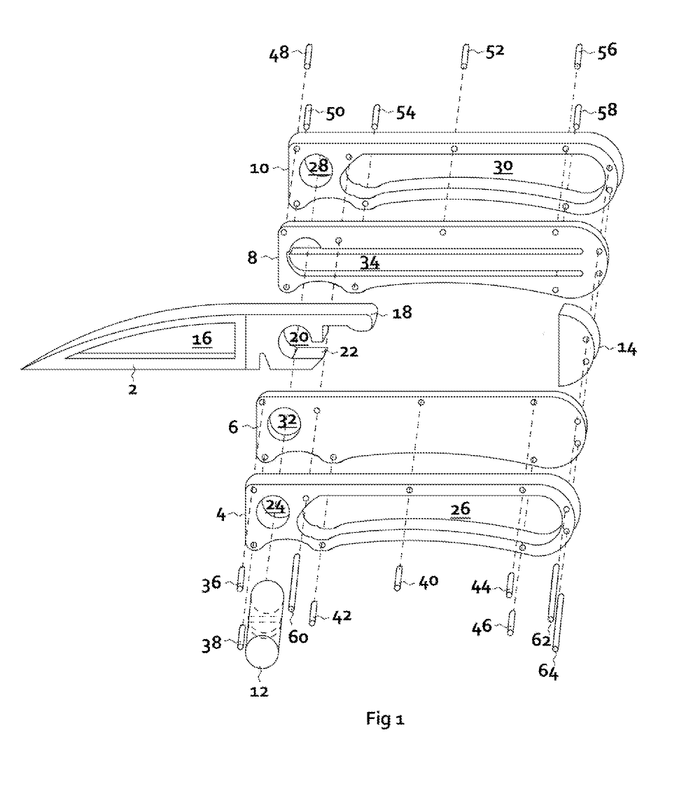

The exploded view of the knife in FIG. 1 shows the general assembly of the knife, which consists of the following main components: the blade 2, scales 4 and 10, the liners 6 and 8, a spacer 14, and the floating pivot 12. The blade 2 includes a cutout 16 for a stone inset, a precision machine hole 20 for the floating pivot 12, a machined face 22 where the locking mechanism 34 wedges, and a tang 18 to facilitate opening the blade. To open the knife, pressure is applied to the tang 18 of the blade 2, providing a force which will rotate the blade on the floating pivot 12 into the open position. The first liner 6 has a precision hole 32 for the pivot mechanism 12. The second liner 8 has the locking spring 34 cut into its body. This is then bent to provide the spring force for the locking mechanism. When fully opened, the locking bar 34 is forced against the locking face 22 of the blade, securing it in the open position; in doing so, the floating pivot 12 moves from one side of the knife to the other. The two scales 4 and 10 have precision holes 24 and 28 drilled into them for the floating pivot 12 as well as cutouts 26 and 30 for stone insets. The floating pivot 12 is precision machined in diameter and contains a precision notch to receive the locking mechanism 34. The spacer 14 is cut to support the back of the knife and provide space for the blade between the sides of the knife Each side of the knife is assembled using small pins 36, 38, 40, 42, 44, 46, 48, 50, 54, 52, 56, and 58 which are peened into place to attach the scale and liner together into a scale assembly; this includes scale 4 with liner 6, and scale 8 with liner 10 respectively. The floating pivot 12 is inserted on the locking mechanism 34 with it extending through the hole 28. To close the blade 2, the extended portion of the floating pivot 12 is pressed, disengaging the locking bar 34 from its contact with the locking face 22, allowing the blade 2 to be rotated on the floating pivot 12 to the closed position. To begin final assembly, first the blade is slid over the pivot 12 using the provided hole 20. The spacer 14 is then set into place at the end of the knife. The other scale assembly is then placed over the floating pivot 12 using the provided holes 24 and 32. Assembly is completed by inserting pins 60, 62, and 64 in their appropriate holes and peening them into place.

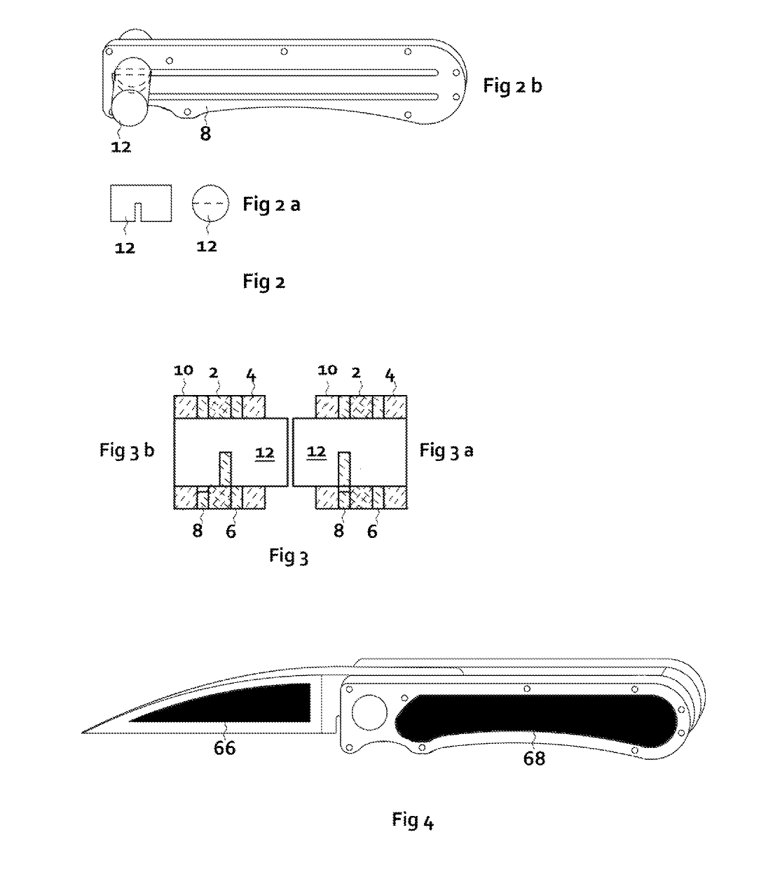

A cross sectional and end view of the floating pivot is shown in FIG. 2a, showing the location of the notch which is machined to provide mounting on the locking spring 34. FIG. 2b shows the floating pivot 12 attached to the locking spring 34.

A cross sectional view through the center of the floating pivot is shown in FIG. 3. FIG. 3 a shows the floating pivot 12, the scales 6 and 8, the liners 4 and 10, and the blade 2. The locking liner 8 has the body and the locking mechanism in alignment, which will allow the blade 2 to pivot. In FIG. 3 b, the floating pivot 8 is pushed to the opposite side, which moves the locking portion of 8 within the notch of the blade 2, thus locking the blade in place in the open position.

A view of the completed knife with the blade in the open position is shown in FIG. 4. Also in place are 2 stone insets 66 and 68, which have been placed in the cutouts 16 and 26.

It will be obvious to those skilled in the art to make various changes, alterations and modifications to the invention described herein. To the extent such changes, alterations and modifications do not depart from the spirit and scope of the appended claims, they are intended to be encompassed therein.

I claim:

1. A liner-locking folding knife comprising:
(a) a handle;
(b) a blade which contains a locking face;
(c) a liner which contains a locking bar which terminates in the floating pivot and contacts the locking face of the blade holding the blade in an open position;
(d) a floating pivot which passes through the handle and blade and has a groove in which the locking mechanism terminates.

2. The folding knife of claim 1 wherein said liner is attached to said handle by means of pins which are peened or by means of threaded fasteners.

3. The folding knife of claim 2 wherein said liner has a portion of the body which is cut to form a locking bar.

4. The folding knife of claim 3 wherein said locking bar has a contact surface.

5. The folding knife of claim 4 wherein said contact surface engages said blade at the said locking face.

6. The folding knife of claim 3 wherein said locking bar terminates in a groove of said floating pivot.

7. The folding knife of claim 1 wherein said blade has a notch at the base.

8. The folding knife of claim 7 wherein the said notch contains a locking face.

9. The folding knife of claim 8 wherein the said locking face is cut with an angle of from 0 to 15 degrees.

10. The folding knife of claim 9 wherein the said angle is optimally 7 to 9 degrees.

11. The folding knife of claim 1 wherein the said floating pivot has a said groove.

12. The folding knife of claim 11 wherein said groove is cut half the distance through said floating pivot.

13. The folding knife of claim 11 wherein said groove is cut in the center of floating pivot.

14. The folding knife of claim 11 wherein said groove is slid over the end of said locking mechanism.

15. The folding knife of claim 11 wherein said floating pivot extends beyond the said handle.

16. The folding knife of claim 15 wherein pressure on said extension of said floating pivot disengages said locking mechanism.

17. The folding knife of claim 11 wherein said floating pivot passes through said blade and said handle, allowing the said blade to pivot open and closed.

18. The folding knife of claim 1 wherein said handles, said blade, and said floating pivot are held together by means of pins which are peened or by means of threaded fasteners.

19. The folding knife of claim 1 wherein said blade has a cutout in the blade.

20. The folding knife of claim 19 wherein said cut-out is filled with a stone inset.
